SEQUENCE LISTING (7 sequences)

SEQ ID NO: 1 - protein, 39 aa, Hadronyche versuta
GSCVPVDQPCSLNTQPCCDDATCTQERNENGHTVYYCRA

SEQ ID NO: 2 - protein, 38 aa, Artificial
  recombinant peptide derived from Hadronyche versuta U-ACTX-Hv1a
QYCVPVDQPCSLNTQPCCDDATCTQERNENGHTVYYCR

SEQ ID NO: 3 - protein, 38 aa, Artificial
  recombinant peptide derived from Hadronyche versuta U-ACTX-Hv1a
QYCVPVDQPCSLNTQPCCDDATCTQELNENDNTVYYCR

SEQ ID NO: 4 - protein, 39 aa, Artificial
  recombinant peptide derived from Hadronyche versuta U-ACTX-Hv1a
QYCVPVDQPCSLNTQPCCDDATCTQERNENGHTVYYCRA

SEQ ID NO: 5 - protein, 39 aa, Artificial
  recombinant peptide derived from Hadronyche versuta U-ACTX-Hv1a
QYCVPVDQPCSLNTQPCCDDATCTQELNENANPVYYCRA

SEQ ID NO: 6 - protein, 39 aa, Artificial; identical to SEQ ID NO: 4
  recombinant peptide derived from Hadronyche versuta U-ACTX-Hv1a

SEQ ID NO: 7 - protein, 39 aa, Artificial
  recombinant peptide derived from Hadronyche versuta U-ACTX-Hv1a
QYCVPVDQPCSLNTQPCCDDATCTQELNENDNTVYYCRA

(19) United States
(12) Patent Application Publication
(10) Pub. No.: US 2007/0281864 A1
(43) Pub. Date: Dec. 6, 2007

(54) Methods of identifying insect-specific spider toxin mimics

(76) Inventors: Glenn F. King, Chapel Hill (AU); Brianna Sollod McFarland, Feton, MO (US)

Correspondence Address: CANTOR COLBURN, LLP, 55 GRIFFIN ROAD SOUTH, BLOOMFIELD, CT, 06002, US

(21) Appl. No.: 11/810,681

(22) Filed: Jun. 6, 2007

Related U.S. Application Data
(60) Provisional application No. 60/811,153, filed on Jun. 6, 2006.

(51) Int. Cl. C40B 30/04; G06G 7/48

(52) U.S. Cl. 506/7; 703/11

(57) ABSTRACT

Disclosed herein are methods of identifying a candidate molecule that mimics at least a portion of the three-dimensional structure of a rU-ACTX-Hv1a insecticidal toxin, the method comprising providing a molecular model made from the atomic co-ordinates for the rU-ACTX-Hv1a insecticidal toxin as disclosed herein, using the molecular model to identify a candidate molecule that mimics the three-dimensional structure of the rU-ACTX-Hv1a insecticidal toxin; and providing the candidate molecule that is identified. The method optionally comprises employing a molecular model identifying the pharmacophoric residues of U-ACTX as Q⁸, P⁹, N²⁸, and V³⁴.

### CROSS REFERENCE TO RELATED APPLICATIONS

This application claims priority to U.S. Provisional Application Ser. No. 60/811,153 filed on Jun. 6, 2006, which is incorporated in its entirety by reference herein.

### STATEMENT REGARDING FEDERALLY SPONSORED RESEARCH & DEVELOPMENT

The U.S. Government has certain rights in this invention pursuant to National Science Foundation Grant No. MCB0234638.

### BACKGROUND

Although only a small minority of insects are classified as pests, they nevertheless destroy around 20% of the world's food supply and transmit a diverse array of human and animal pathogens. Control of insect pests is therefore an issue of worldwide agronomic and medical importance. Arthropod pests such as insects have been controlled primarily with chemical insecticides ever since the introduction of DDT in the 1940s. However, control of insect pests in the United States and elsewhere in the world is becoming increasingly complicated for several reasons. First, chemical control subjects the insect population to Darwinian selection and, as a consequence, more than 500 species of arthropods have developed resistance to one or more classes of chemical insecticides. Second, growing awareness of the undesirable environmental and ecological consequences of chemical insecticides, such as toxicity to non-target organisms, has led to revised government regulations that place greater demands on insecticide risk assessment. The loss of entire classes of insecticides due to resistance development or de-registration, combined with more demanding registration requirements for new insecticides, is likely to decrease the pool of effective chemical insecticides in the near future.

A number of investigators have recognized spider venoms as a possible source of insect-specific toxins for agricultural and other applications. A class of peptide toxins known as the omega-atracotoxins are disclosed in U.S. Pat. No. 5,763,568 as being isolated from Australian funnel-web spiders by screening the venom for “anti-cotton bollworm” activity. One of these compounds, designated omega-ACTX-Hv1a, has been shown to selectively inhibit insect, as opposed to mammalian, voltage-gated calcium channel currents. A second, unrelated family of insect-specific peptidic calcium channel blockers are disclosed as being isolated from the same family of spiders in U.S. Pat. No. 6,583,264.

While several insecticidal peptide toxins isolated from scorpions and spiders appear to be promising leads for the development of insecticides, there still remains a significant need for compounds that act quickly and with high potency against insects, but which display a differential toxicity between insects and vertebrates.

### SUMMARY

In one embodiment, a method of identifying a candidate molecule that mimics at least a portion of a three-dimensional structure of a U-ACTX insecticidal toxin comprises providing a molecular model made from the atomic coordinates for the rU-ACTX-Hv1a insecticidal toxin having PDB ID 2H1Z and RCSB ID RCSB037828; using the molecular model to identify a candidate molecule that mimics the structure of the rU-ACTX-Hv1a molecular model; and providing the candidate molecule that is identified.

In another embodiment, a method for selecting a candidate molecule that mimics at least a portion of a three-dimensional structure of rU-ACTX-Hv1a comprises providing a computer having a memory means, a data input means, and a visual display means, the memory means containing three-dimensional molecular simulation software operable to retrieve coordinate data from the memory means and to display a three-dimensional representation of rU-ACTX-Hv1a on the visual display means; inputting three-dimensional coordinate data of atoms of rU-ACTX-Hv1 having PDB ID 2H1Z and RCSB ID RCSB037828 into the computer and storing the data in the memory means; displaying the three-dimensional representation of the candidate molecule on the visual display means; comparing the three-dimensional structure of rU-ACTX-Hv1a and the candidate molecule; and providing the candidate molecule.

In yet another embodiment, a method of identifying a molecule that mimics at least a portion of a three-dimensional structure of a U-ACTX insecticidal toxin, comprising: generating a three-dimensional model of the U-ACTX polypeptide, identifying pharmacophoric residues Q⁸, P⁹, N²⁸, and V³⁴ in the three-dimensional model, and performing a computer analysis to identify a candidate molecule that mimics the pharmacophoric residues of the U-ACTX polypeptide.

### BRIEF DESCRIPTION OF THE DRAWINGS

FIG. 1 shows a comparison of the primary structures of various members of the U-ACTX family of insecticidal peptide toxins (SEQ ID NOs. 1-7). rU-ACTX-Hv1a (SEQ ID NO: 1) is a recombinant version of one of the native peptide toxins (SEQ ID NO:2) in which the two N-terminal residues (Gln-Tyr) have been replaced with Gly-Ser for cloning purposes.

FIG. 2 shows a wall-eyed stereo view of the ensemble of 25 rU-ACTX-Hv1a structures (PDB file 2H1Z) overlaid for optimal superposition over the backbone atoms (C_{α}, C, and N) of residues 3-39. The N- and C-termini of the peptide toxin are labeled “N” and “C”, respectively. The three disulfide bonds are shown as light grey tubes, and each disulfide bond is labeled with the residue numbers of the two cysteine residues that form the disulfide bond.

FIG. 3 shows a Ramachandran plot for the ensemble of 25 rU-ACTX-Hv1a structures as determined using the computer program PROCHECK. The statistics calculated by the PROCHECK program are shown below the Ramachandran plot.

FIG. 4 shows a Richardson schematic of the three-dimensional structure of rU-ACTX-Hv1a based on the coordinates of the model from the ensemble with the lowest molecular energy (Model 1 in PDB file 2H1Z). The schematic is shown as a wall-eyed stereo image. The arrows represent the two β-strands (β1=residues 22-27; β2=residues 33-38) that form a C-terminal hairpin. The N- and C-termini of the peptide toxin are labeled “N” and “C”, respectively. For this figure, the molecule has been rotated approximately 90° around its long axis relative to the orientation shown in FIG. 2.

FIG. 5 shows a Richardson schematic of the three-dimensional structure of rU-ACTX-Hv1a based on the coordinates of the model from the ensemble with the lowest molecular energy (Model 1 in PDB file 2H1Z). The sidechains of key functional residues Gln8, Pro9, Asn28, and Val34, as determined from alanine scanning mutagenesis experiments, are shown as black tubes. The orientation of the molecule is similar to that shown in FIG. 4. The N-terminus of the peptide toxin is labeled “N”.

FIG. 6 shows a representation of the molecular surface of the three-dimensional structure of rU-ACTX-Hv1a based on the coordinates of the model from the ensemble with the lowest molecular energy (Model 1 in PDB file 2H1Z). The surface of the key pharmacophoric elements of rU-ACTX-Hv1a (Gln8, Pro9, Asn28, and Val34) are highlighted in black.

The above-described and other features will be appreciated and understood by those skilled in the art from the following detailed description, drawings, and appended claims.

### DETAILED DESCRIPTION

The present invention is based, at least in part, upon the determination of the three-dimensional structure of an insecticidal peptide toxin known as U-ACTX-Hv1a. The present invention is also based, at least in part, upon the determination of the pharmacophore of this toxin. It has been unexpectedly discovered by the inventors herein that four residues, Q⁸, P⁹, N²⁸, and V³⁴, of the U-ACTX polypeptides provide the insecticidal activity of the polypeptides.

U-ACTX-Hv1a is the prototypic member of a family of insecticidal peptide toxins described in US 2006/242734, which is incorporated herein by reference in its entirety. These insecticidal toxins comprise 38-39 residues, including six conserved cysteine residues that are paired to form three disulfide bonds. U-ACTX polypeptides cause irreversible toxicity when injected into insects such as the house fly Musca domestica, the house cricket Acheta domestica, and other insect species. These toxins have the unique ability to block both insect voltage-gated calcium channels and insect calcium-activated potassium channels.

rU-ACTX-Hv1a (SEQ ID NO:1) is a recombinant polypeptide in which the first two residues of the native sequence of U-ACTX-Hv1a (Gln-Tyr) (SEQ ID. NO: 2) have been replaced with Gly-Ser to give the following sequence:

SEQ ID NO: 1: Gly-Ser-Cys-Val-Pro-Val-Asp-Gln-Pro-Cys-Ser-Leu-Asn-Thr-Gln-Pro-Cys-Cys-Asp-Asp-Ala-Thr-Cys-Thr-Gln-Glu-Arg-Asn-Glu-Asn-Gly-His-Thr-Val-Tyr-Tyr-Cys-Arg-Ala

(GSCVPVDQPCSLNTQPCCDDATCTQERNENGHTVYYCRA)

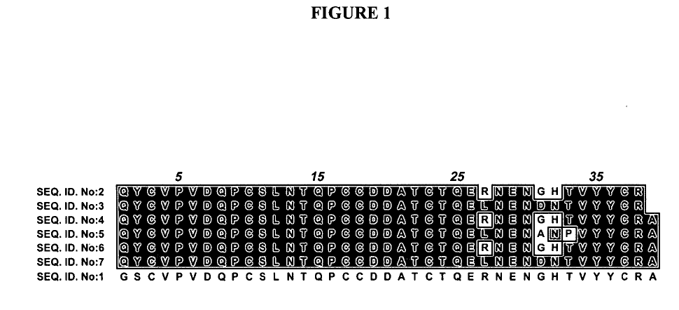

Other Variants of U-Actx, SEQ ID Nos: 3-7 are Shown in FIG. 1. Other homologs of U-ACTX-Hv1a may be employed, for example, homologs that are greater than or equal to about 70%, 85%, 90%, or 95% identical to SEQ ID NO: 1, wherein the homologous polypeptide has insecticidal activity. “Homolog” is a generic term used in the art to indicate a polynucleotide or polypeptide sequence possessing a high degree of sequence relatedness to a subject sequence. Such relatedness may be quantified by determining the degree of identity and/or similarity between the sequences being compared. As used herein, “percent homology” of two amino acid sequences or of two nucleic acids is determined using the algorithm of Karlin and Altschul (1990) Proc. Natl. Acad. Sci., U.S.A. 87, 2264-2268. Such an algorithm is incorporated into the NBLAST and XBLAST programs of Altschul et al. (1990) J. Mol. Biol. 215, 403-410.

Production of milligram quantities of rU-ACTX-Hv1a using an E. coli expression system was described in US 2006/242734.

Reference is made to the sets of atomic co-ordinates and related tables included with this specification as Table 3 and submitted on compact disk 1.

It will be apparent to those of ordinary skill in the art that the structure of U-ACTX-Hv1a presented herein is independent of its orientation, and that the coordinates identified herein merely represent one possible orientation of a particular toxin. It is apparent, therefore, that the atomic coordinates identified herein may be mathematically rotated, translated, scaled, or a combination thereof, without changing the relative positions of atoms or features of the respective structure. Such mathematical manipulations are embraced herein.

As used herein the terms “bind”, “binding”, “bound”, “bond”, or “bonded”, when used in reference to the association of atoms, molecules, or chemical groups, refer to physical contact or association of two or more atoms, molecules, or chemical groups. Such contacts and associations include covalent and non-covalent types of interactions.

As used herein, the term “hydrogen bond” refers to two electronegative atoms (either O or N) which share a hydrogen that is covalently bonded to only one atom, while interacting with the other.

As used herein, the term “hydrophobic interaction” refers to interactions made by two hydrophobic residues.

As used herein, “noncovalent bond” refers to an interaction between atoms and/or molecules that does not involve the formation of a covalent bond between them.

As used herein, the term “molecular graphics” refers to three-dimensional representations of atoms, preferably on a computer screen.

As used herein, the terms “molecular model” or “molecular structure” refer to the three-dimensional arrangement of atoms within a particular object (e.g., the three-dimensional structure of the atoms that comprise a toxin).

As used herein, the term “molecular modeling” refers to a method or procedure that can be performed with or without a computer to make one or more models, and, optionally, to make predictions about structure-activity relationships of ligands. The methods used in molecular modeling range from molecular graphics to computational chemistry.

As used herein, the term “pharmacophore” refers to an ensemble of interactive functional groups with a defined geometry that are responsible for the biological activity of a U-ACTX polypeptide.

In general, a pharmacophore is specified by the precise electronic properties on the surface of the active residues that cause binding to the surface of the target molecule (i.e., an insect ion channel). Typically, these properties are specified by the underlying chemical structures (e.g., aromatic groups, functional groups such as —COOH, etc.) and their geometric relationships. In a nonlimiting aspect, the geometric relations are precise to at least 2 Angstroms, more specifically, at least 1 Angstrom. A pharmacophore may include the identification of 2 to 4 of such groups (i.e., pharmacophoric elements or features). However, for complex protein recognition targets, a pharmacophore may include a greater number of groups.

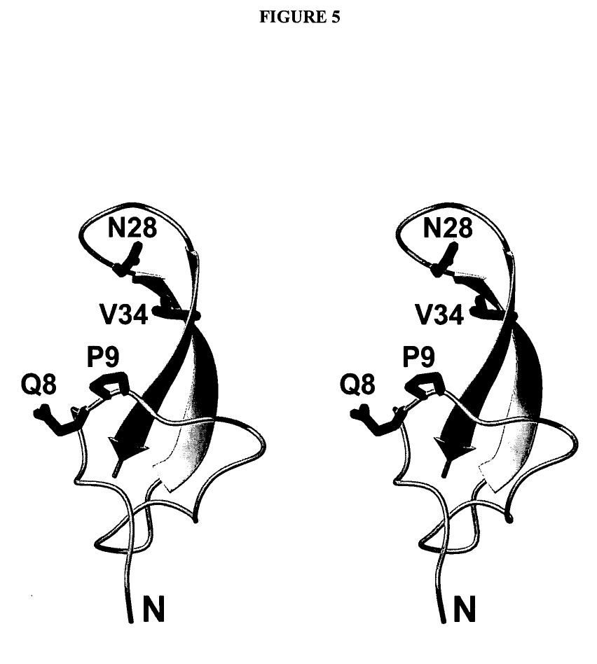

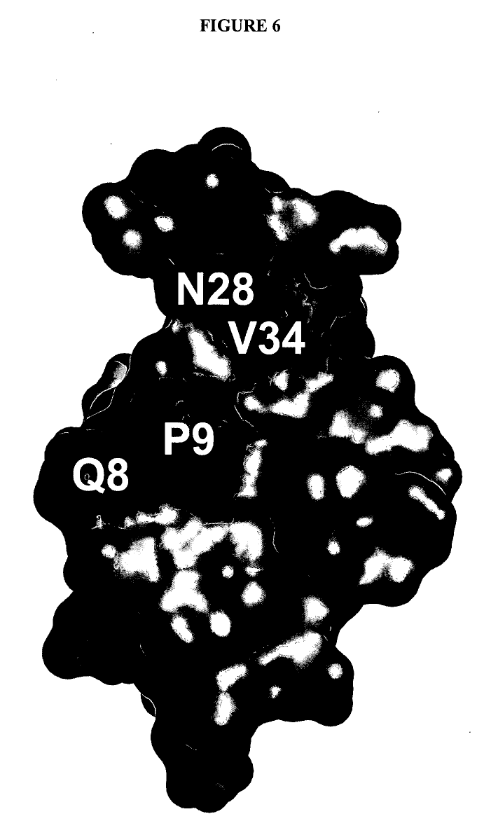

The core pharmacophoric residues of the U-ACTX toxin include the amino acid residues Q⁸, P⁹, N²⁸, and V³⁴, as shown in FIGS. 5-6.

“Fundamental pharmacophoric specification” refers to both the chemical groups making up the pharmacophore and the geometric relationships of these groups. Several chemical arrangements may have similar electronic properties. For example, if a pharmacophoric specification includes an —OH group at a particular position, a substantially equivalent specification includes an —SH group at the same position. Equivalent chemical groups that may be substituted in a pharmacophoric specification without substantially changing its nature are homologous.

As used herein, “U-ACTX mimic” refers to a molecule that interacts with an insect voltage-gated calcium channel, an insect calcium-activated potassium channel, or both of these channels, and thus functions as a U-ACTX toxin. In one embodiment, the U-ACTX mimic interacts with both an insect voltage-gated calcium channel and an insect calcium-activated potassium channel. The term mimic encompasses molecules having portions similar to corresponding portions of the U-ACTX pharmacophore in terms of structure and/or functional groups.

In one embodiment, the methods described herein include the use of molecular and computer modeling techniques to design and/or select novel molecules that mimic the U-ACTX family of toxins.

In one embodiment, a method of identifying a candidate molecule that mimics at least a portion of a three-dimensional structure of a U-ACTX insecticidal toxin comprises providing a molecular model made from the atomic coordinates for the rU-ACTX-Hv1a insecticidal toxin having PDB ID 2H1Z and RCSB ID RCSB037828 (Table 3); using the molecular model to identify a candidate molecule that mimics the structure of the rU-ACTX-Hv1a molecular model; and providing the candidate molecule that is identified. Optionally, the method further comprises identifying the pharmacophoric residues Q⁸, P⁹, N²⁸, and V³⁴ in the molecular model while using the molecular model.

The atomic coordinates of rU-ACTX-Hv1a, optionally in combination with the fundamental pharmacophoric specification of rU-ACTX-Hv1a, may be used in rational drug design (RDD) to design a novel molecule of interest, for example, novel ion channel modulators (for example, rational design of insecticides that behave as structural and functional mimics of rU-ACTX-Hv1a). Furthermore, by using the principles disclosed herein, the skilled artisan can design, make, test, refine and use novel insecticides specifically engineered to kill or paralyze insects, or to inhibit insect development or growth in such a manner that, for example in the case of agricultural applications, the insects provide less damage to a plant, and plant yield is not significantly adversely affected. For example, by using the principles discussed herein, the skilled artisan can engineer new molecules that functionally mimic rU-ACTX-Hv1a. As a result, the molecular structure and optionally the fundamental pharmacophoric specification provided and discussed herein permit the skilled artisan to design new insecticidal toxins, including small molecule toxins as well as polypeptide toxins.

RDD using the atomic coordinates of a U-ACTX-Hv1a can be facilitated most readily via computer-assisted drug design (CADD) using computer hardware and software known and used in the art. The candidate molecules may be designed de novo or may be designed as a modified version of an already existing molecule, for example, a pre-existing toxin. Once designed, candidate molecules can be synthesized using methodologies known and used in the art, or obtained from a library of compounds. Once they have been obtained, the candidate molecules are optionally screened for bioactivity, for example, for their ability to inhibit insect ion channels. Optionally, the structure of the candidate molecule is elucidated to determine how closely the structure mimics the pharmacophoric elements of rU-ACTX-Hv1a. Based in part upon these results, the candidate molecules may be refined iteratively using one or more of the foregoing steps to produce a more desirable molecule with a desired biological activity.

The tools and methodologies provided herein may be used to identify and/or design molecules that have insecticidal activity. Essentially, the procedures utilize an iterative process whereby the candidate molecules are synthesized, tested, and characterized. New molecules are designed based on the information gained in the testing and characterization of the initial molecules and then such newly identified molecules are themselves tested and characterized. This series of processes may be repeated as many times as necessary to obtain molecules with desirable binding properties and/or biological activities. Methods for identifying candidate molecules are discussed in more detail below.

The design of candidate molecules of interest can be facilitated by ball and stick-type physical modeling procedures. However, in view of the size of the rU-ACTX-Hv1a toxin, the ability to design candidate molecules may be enhanced significantly using computer-based modeling and design protocols.

In one embodiment, selection of a candidate molecule also includes providing a computer having a memory means, a data input means and a visual display means in operable communication. The memory means contains three-dimensional molecular simulation software operable to retrieve coordinate data from the memory means and operable to display a three-dimensional representation of the molecule or a portion thereof on the visual display means. This software is operable to produce a modified three-dimensional analog representation responsive to operator-selected changes to the chemical structure of the domain and is operable to display the three-dimensional representation of the modified analog. The date input means includes a central processing unit for processing computer readable data. This method optionally also includes inputting three-dimensional coordinate data of atoms of rU-ACTX-Hv1a into the computer and storing the data in the memory means; inputting into the data input means of the computer at least one operator-selected change in chemical structure of rU-ACTX-Hv1a; executing the molecular simulation software to produce a modified three-dimensional molecular representation of the analog structure; displaying the three-dimensional representation of the analog on the visual display means; whereby changes in three-dimensional structure of rU-ACTX-Hv1a consequent on changes in chemical structure can be visually monitored. The method also optionally includes inputting operator-selected changes in the chemical structure of rU-ACTX-Hv1a; executing the software to produce a modified three-dimensional molecular representation of the analog structure; and displaying the three-dimensional representation of the analog on the visual display means. The method also includes selecting a candidate compound structure represented by a three-dimensional representation and comparing the three-dimensional representation to the three-dimensional configuration and spatial arrangement of pharmacophoric regions involved in function of rU-ACTX-Hv1a.

The design of candidate molecules is optionally facilitated using computers or workstations, available commercially from, for example, Silicon Graphics Inc., Apple Computer Inc., and Sun Microsystems, running, for example, UNIX based, or Windows operating systems, and capable of running suitable computer programs for molecular modeling and rational drug design.

In one embodiment, the computer-based systems comprise a data storage means having stored therein the atomic coordinates and optionally the fundamental pharmacophoric specification of rU-ACTX-Hv1a as described herein, and the necessary hardware means and software means for supporting and implementing an analysis means. As used herein, “a computer system” or “a computer-based system” refers to the hardware means, software means, and data storage means used to analyze the sequence, molecular structure and optionally the fundamental pharmacophoric specification as described herein. As used herein, the term “data storage means” is understood to refer to a memory which can store sequence data, or a memory access means which can access manufactures having recorded thereon the molecular structure of the present invention.

In one embodiment, the atomic coordinates of rU-ACTX-Hv1a and optionally the fundamental pharmacophoric specification of this polypeptide toxin are recorded on a computer readable medium. As used herein, the term “computer readable medium” is understood to mean a medium that can be read and accessed directly by a computer. Such media include, but are not limited to: magnetic storage media, such as floppy discs, hard disc storage medium, and magnetic tape; optical storage media such as optical discs or CD-ROM; electrical storage media such as RAM and ROM; and hybrids of these categories such as magnetic/optical storage media. A skilled artisan can readily appreciate how computer readable media can be used to create a manufacture comprising computer readable medium having recorded thereon an amino acid and/or nucleotide sequence, molecular structures, and/or atomic co-ordinates of the present invention.

As used herein, the term “recorded” refers to a process for storing information on a computer readable medium. A skilled artisan can readily adopt the presently known methods for recording information on a computer readable medium to generate manufactures comprising an amino acid or nucleotide sequence, atomic coordinates and/or NMR data.

A variety of data storage structures are available to a skilled artisan for creating a computer readable medium having recorded thereon amino acid and/or nucleotide sequences, atomic coordinates and/or NMR data. The choice of the data storage structure will generally be based on the means chosen to access the stored information. In addition, a variety of data processor programs and formats can be used to store the sequence information, NMR data, and/or atomic coordinates on computer readable medium. The foregoing information, data and coordinates can be represented in a word processing text file, formatted in commercially-available software such as WordPerfect and Microsoft Word, or represented in the form of an ASCII file, stored in a database application, such as DB2, Sybase, Oracle, or the like. A skilled artisan can readily adapt a number of data processor structuring formats (e.g., text file or database) in order to obtain computer readable medium having recorded thereon the information.

By providing a computer readable medium having stored thereon the sequence and atomic coordinates of rU-ACTX-Hv1a, a skilled artisan can routinely access the sequence, and/or atomic coordinates to model a different U-ACTX toxin, a subdomain of the toxin, or a mimetic of the toxin. Computer algorithms are publicly and commercially available which allow a skilled artisan to access this data provided in a computer readable medium and analyze it for molecular modeling and/or RDD.

Although computers are not required, molecular modeling can be most readily facilitated by using computers to build realistic models of rU-ACTX-Hv1a, or portions thereof, such as the fundamental pharmacophoric specification of rU-ACTX-Hv1a. Molecular modeling also permits the modeling of smaller molecules that structurally mimic the toxin. The methods utilized in molecular modeling range from molecular graphics (i.e., three-dimensional representations) to computational chemistry (i.e., calculations of the physical and chemical properties) to make predictions about the structure and activity of the smaller molecules, and to design new molecules.

For basic information on molecular modeling, see, for example, U.S. Pat. Nos. 6,093,573; 6,080,576; 6,075,014; 6,075,123; 6,071,700; 5,994,503; 5,884,230; 5,612,894; 5,583,973; 5,030,103; and 4,906,122; incorporated herein by reference.

Three-dimensional modeling can include, but is not limited to, making three-dimensional representations of structures, drawing pictures of structures, building physical models of structures, and determining the structures of related toxins and toxin/ligand complexes using the known coordinates. The appropriate coordinates are entered into one or more computer programs for molecular modeling. By way of illustration, a list of computer programs useful for viewing or manipulating three-dimensional structures include: Midas (University of California, San Francisco); MidasPlus (University of California, San Francisco); MOIL (University of Illinois); Yummie (Yale University); Sybyl (Tripos, Inc.); Insight/Discover (Biosym Technologies); MacroModel (Columbia University); Quanta (Molecular Simulations, Inc.); Cerius (Molecular Simulations, Inc.); Alchemy (Tripos, Inc.); LabVision (Tripos, Inc.); Rasmol (Glaxo Research and Development); Ribbon (University of Alabama); NAOMI (Oxford University); Explorer Eyechem (Silicon Graphics, Inc.); Univision (Cray Research); Molscript (Uppsala University); Chem-3D (Cambridge Scientific); Chain (Baylor College of Medicine); 0 (Uppsala University); GRASP (Columbia University); X-Plor (Molecular Simulations, Inc.; Yale University); Spartan (Wavefunction, Inc.); Catalyst (Molecular Simulations, Inc.); Molcadd (Tripos, Inc.); VMD (University of Illinois/Beckman Institute); Sculpt (Interactive Simulations, Inc.); Procheck (Brookhaven National Library); DGEOM (QCPE); RE_VIEW (Brunell University); Modeller (Birbeck College, University of London); Xmol (Minnesota Supercomputing Center); Protein Expert (Cambridge Scientific); HyperChem (Hypercube); MD Display (University of Washington); PKB (National Center for Biotechnology Information, NIH); ChemX (Chemical Design, Ltd.); Cameleon (Oxford Molecular, Inc.); Iditis (Oxford Molecular, Inc.); and PyMol (DeLano Scientific LLC).

One approach to RDD is to search for known molecular structures that mimic a site of interest. Using molecular modeling, RDD programs can look at a range of different molecular structures of molecules that mimic a site of interest, and by moving them on the computer screen or via computation it can be decided which compounds are the best structural mimics of the site of interest. For example, molecular modeling programs could be used to determine which one of a given set of compounds was the best structural mimic of the pharmacophoric regions of rU-ACTX-Hv1a.

In order to facilitate molecular modeling and/or RDD the skilled artisan may use some or all of the atomic coordinates deposited at the RCSB Protein Data Bank with the accession number PDB ID 2H1Z and RCSB ID RCSB037828, and/or those atomic coordinates in Table 3. By using the foregoing atomic coordinates, the skilled artisan can design structural mimics of U-ACTX toxins.

The atomic coordinates provided herein are also useful in designing improved analogues of known insecticidal toxins.

The atomic coordinates presented herein also permit comparing the three-dimensional structure of a U-ACTX toxin or a portion thereof with molecules composed of a variety of different chemical features to determine optimal sites to mimic the U-ACTX toxin structure.

The atomic coordinates of a U-ACTX toxin permit the skilled artisan to identify target locations in a toxin that can serve as a starting point in rational drug design. In particular, the identification of the fundamental pharmacophoric specification of the U-ACTX toxins allows one to identify residues and functional groups that are key for toxin function.

A candidate molecule comprises, but is not limited to, at least one of a lipid, nucleic acid, peptide, small organic or inorganic molecule, chemical compound, element, saccharide, isotope, carbohydrate, imaging agent, lipoprotein, glycoprotein, enzyme, analytical probe, and an antibody or fragment thereof, any combination of any of the foregoing, and any chemical modification or variant of any of the foregoing. In addition, a candidate molecule may optionally comprise a detectable label. Such labels include, but are not limited to, enzymatic labels, radioisotope or radioactive compounds or elements, fluorescent compounds or metals, chemiluminescent compounds and bioluminescent compounds. Well known methods may be used for attaching such a detectable label to a candidate molecule.

Methods useful for synthesizing candidate molecules such as lipids, nucleic acids, peptides, small organic or inorganic molecules, chemical compounds, saccharides, isotopes, carbohydrates, imaging agents, lipoproteins, glycoproteins, enzymes, analytical probes, antibodies, and antibody fragments are well known in the art. Such methods include the approach of synthesizing one such candidate molecule, such as a single defined peptide, one at a time, as well as combined synthesis of multiple candidate molecules in one or more containers. Such multiple candidate molecules may include one or more variants of a previously identified candidate molecule. Methods for combined synthesis of multiple candidate molecules are particularly useful in preparing combinatorial libraries, which may be used in screening techniques known in the art.

By way of example, multiple peptides and oligonucleotides may be simultaneously synthesized. Candidate molecules that are small peptides, up to about 50 amino acids in length, may be synthesized using standard solid-phase peptide synthesis procedures. For example, during synthesis, N-α-protected amino acids having protected side chains are added stepwise to a growing polypeptide chain linked by its C-terminal end to an insoluble polymeric support, e.g., polystyrene beads. The peptides are synthesized by linking an amino group of an N-α-deprotected amino acid to an α-carboxy group of an N-α-protected amino acid that has been activated by reacting it with a reagent such as dicyclohexylcarbodiimide. The attachment of a free amino group to the activated carboxyl leads to peptide bond formation. The most commonly used N-α-protecting groups include Boc, which is acid labile, and Fmoc, which is base labile.

Briefly, the C-terminal N-α-protected amino acid is first attached to the polystyrene beads. Then, the N-α-protecting group is removed. The deprotected α-amino group is coupled to the activated α-carboxylate group of the next N-α-protected amino acid. The process is repeated until the desired peptide is synthesized. The resulting peptides are cleaved from the insoluble polymer support and the amino acid side chains are deprotected. Longer peptides, for example greater than about 50 amino acids in length, are derived by condensation of protected peptide fragments. Details of appropriate chemistries, resins, protecting groups, protected amino acids and reagents are well known in the art.

Purification of the resulting peptide is accomplished using procedures such as reverse-phase, gel permeation, and/or ion exchange chromatography. The choice of appropriate matrices and buffers are well known in the art.

A synthetic peptide comprises naturally occurring amino acids, unnatural amino acids, and/or amino acids having specific characteristics, such as, for example, amino acids that are positively charged, negatively charged, hydrophobic, hydrophilic, or aromatic. Amino acids used in peptide synthesis include L- or D-stereoisomers.

Many of the known methods useful in synthesizing compounds may be automated, or may otherwise be practiced on a commercial scale. As such, once a candidate molecule has been identified as having commercial potential, mass quantities of that molecule may easily be produced. Candidate molecules can be designed entirely de novo or may be based upon a pre-existing insecticidal toxin. Either of these approaches can be facilitated by computationally screening databases and libraries of small molecules for chemical entities, agents, ligands, or compounds that can mimic an insecticidal toxin.

The potential structural similarity of a compound to the fundamental pharmacophoric specification of rU-ACTX-Hv1a can be predicted before its actual synthesis and assay by the use of computer modeling techniques. If the theoretical structure of the candidate molecule suggests insufficient structural similarity, synthesis and testing of the candidate molecule is obviated. However, if computer modeling indicates a strong structural similarity, the molecule is synthesized and tested for its ability to act as an insecticidal toxin. In this manner, synthesis of inoperative molecules may be avoided. In some cases, inactive molecules are synthesized predicted on modeling and then tested to develop a SAR (structure-activity relationship) for molecules having particular structural features. As used herein, the term “SAR” refers to the structure-activity/structure property relationships pertaining to the relationship(s) between a compound's activity/properties and its chemical structure.

Several factors can be taken into account when selecting/designing mimics of rU-ACTX-Hv1a. First, the mimic should mimic at least a portion of the pharmacophoric specification of rU-ACTX-Hv1a. The functional groups on the mimic should be assessed for their ability to participate in hydrogen bonding, van der Waals interactions, hydrophobic interactions, and electrostatic interactions. Second, the mimic should be able to assume a conformation that allows it to mimic at least a portion of the structure of rU-ACTX-Hv1a. Such conformational factors include the overall three-dimensional structure and orientation of the mimic in relation to all or a portion of the structure of rU-ACTX-Hv1a, or the spacing between functional groups of a mimic comprising several chemical entities that directly interact with the molecular targets of U-ACTX-Hv1a and similar toxins.

One skilled in the art may use one or more of several methods to identify chemical moieties or entities, compounds, or other agents for their ability to mimic the three-dimensional structure of rU-ACTX-Hv1a, or a portion thereof, such as the fundamental pharmacophoric specification as identified herein. This process may begin by visual inspection or computer assisted modeling of, for example, the pharmacophore of rU-ACTX-Hv1a, using the atomic coordinates deposited in the RCSB Protein Data Bank (PDB) with Accession Number PDB ID 2H1Z and RCSB ID RCSB037828. In one embodiment, compound design uses computer modeling programs that calculate how well a particular molecule mimics the structure of rU-ACTX-Hv1a. Selected chemical moieties or entities, compounds, or agents are positioned in a variety of orientations. Databases of chemical structures are available from, for example, Cambridge Crystallographic Data Center (Cambridge, U.K.) and Chemical Abstracts Service (Columbus, Ohio).

Specialized computer programs also assist in the process of selecting chemical entities. Once suitable chemical moieties or entities, compounds, or agents have been selected, they can be assembled into a single molecule. Assembly may proceed by visual inspection and/or computer modeling and computational analysis of the spatial relationship of the chemical moieties or entities, compounds or agents with respect to one another in three-dimensional space. This could then be followed by model building and energy minimization using software such as Quanta or Sybyl optionally followed by energy minimization and molecular dynamics with standard molecular mechanics force fields, such as CHARMM and AMBER.

Useful programs to aid in choosing and connecting the individual chemical entities, compounds, or agents include but are not limited to: GRID (University of Oxford); CATALYST (Accelrys, San Diego, Calif.); AUTODOCK (Scripps Research Institute, La Jolla, Calif.); DOCK (University of California, San Francisco, Calif.); ALADDIN; CLIX; GROUPBUILD; GROW; and MOE (Chemical Computing Group).

In one embodiment, the test molecule mimics one or more key chemical features of the rU-ACTX-Hv1a pharmacophoric specification, such as the hydrogen-bonding capacity. In one specific exemplary embodiment, a test compound mimics the hydrogen-bonding capacity of the sidechain amide moiety of Gln⁸.

Instead of proceeding to build a molecule of interest in a step-wise fashion one chemical entity at a time as described above, the molecule of interest are designed as a complete entity using either the complete fundamental pharmacophoric specification of rU-ACTX-Hv1a, or a portion thereof. During modeling, it is possible to introduce into the molecule of interest, chemical moieties that are beneficial for a molecule that is to be administered as an insecticide. For example, it is possible to introduce into, or omit from, the molecule of interest, chemical moieties that may not directly affect binding of the molecule to the target ion channel, but which contribute, for example, to the overall solubility of the molecule in an agriculturally acceptable carrier, the bioavailability of the molecule, and/or the toxicity of the molecule.

Instead of designing molecules of interest entirely de novo, pre-existing molecules or portions thereof may be used as a starting point for the design of a new candidate. Many of the approaches useful for designing molecules de novo are also be useful for modifying existing molecules.

Knowledge of the structure of an insecticidal toxin relative to the structure of rU-ACTX-Hv1a may allow for the design of a new toxin that has better insecticidal activity relative to the molecule from which it was derived. A variety of modified molecules are designed using the atomic coordinates provided herein. For example, by knowing the spatial relationship of one or more insecticidal peptide toxins relative to the structure of rU-ACTX-Hv1a, it is possible to generate new polypeptide toxins with improved insecticidal properties.

Once a candidate molecule has been designed or selected by the above methods, its similarity to a rU-ACTX-Hv1a toxin is determined by computational evaluation and/or by testing its biological activity after the compound has been synthesized. In addition, substitutions may then be made in some of the atoms or side groups of the candidate molecule in order to improve or modify its properties. Generally, initial substitutions are conservative, i.e., the replacement group will approximate the same size, shape, hydrophobicity and charge as the original group. It should, of course, be understood that components known to alter conformation should be avoided. In one embodiment, such substituted chemical compounds are analyzed for structural similarity with U-ACTX by the same computer methods described in detail, above.

In one embodiment; the method further comprises using the molecular model, or a portion thereof, to identify a modified candidate molecule and produce a modified candidate molecule having a higher lethality to insects, enhanced inhibition of insect calcium channels, enhanced inhibition of insect calcium-activated potassium channels, enhanced binding to insect calcium channels, enhanced binding to insect calcium-activated potassium channels, or an enhancement of one or more of the foregoing functionalities relative to the candidate molecule.

In one embodiment, molecules designed, selected and/or optimized by methods described above, once produced, are characterized using a variety of assays to determine whether the compounds have biological activity. For example, the molecules are characterized by assays, including but not limited to those assays described below, to determine whether they have a predicted activity, binding activity and/or binding specificity. Suitable assays measure, for example, the ability of the chosen molecule to kill or paralyze insects, inhibit insect calcium channels, inhibit insect calcium-activated potassium channels, bind insect calcium channels, bind insect calcium-activated potassium channels, and combinations comprising one or more of the foregoing functions.

(1) Lethality to insects. The activity of a candidate molecule can be determined quantitatively by direct injection of the candidate molecule into an insect such as Musca domestica (house flies). In an exemplary protocol, house flies (body weight 10 to 25 mg) are injected with 1 to 2 μl of candidate molecule dissolved in insect saline. Control flies are injected with 2 μl of insect saline. An Arnold microapplicator (Burkard Scientific Supply, Rickmansworth, England) equipped with a 29-gauge needle, for example, is employed to administer the injections. Specimens can be temporarily immobilized at 4° C. for the injections and then immediately returned to room temperature (24° C.).

The LD₅₀ value (i.e., the dose of candidate molecule that kills 50% of flies at 24 hours post-injection) may be calculated by fitting the following equation to the resultant log dose-response curve:
y=(a−b)/[1+(x/LD₅₀)ⁿ]
where y is the percentage deaths in the sample population at 24 hours post-injection, x is the toxin dose in pmol g⁻¹, n is a variable slope factor, a is the maximum response and b is the minimum response.

(2) Electrophysiological assays. Inhibition of insect ion channels may be studied using isolated insect neurons, in recombinant cells or oocytes expressing a specific channel, or a combination comprising one or more of the foregoing. In one embodiment, the ion channels to be tested are voltage-gated calcium channels and/or calcium-activated potassium channels naturally found in an insect neuronal system.

In one embodiment, the activity of a test compound is assessed by its ability to inhibit the activity of an isolated insect neuron. In one embodiment, dorsal unpaired median (DUM) neurons isolated from the terminal abdominal ganglion (TAG) of cockroach Periplaneta americana are employed. DUM neurons contain voltage-gated calcium channels (Ca_{V} channels) from which Caᵥ channel currents (I_{Ca}) can be recorded using whole-cell patch-clamp recording techniques. DUM neuron cell bodies are isolated from the midline of the TAG of the nerve cord of P. Americana. In one embodiment, cockroaches are anaesthetized by cooling at −20° C. for approximately 5 minutes. They are then pinned dorsal side up on a dissection dish, and the dorsal cuticle, gut contents, and longitudinal muscles are removed. The ganglionic nerve cord is identified, and the TAG is carefully removed and placed in normal insect saline (NIS) containing 200 mM NaCl, 3.1 mM KCl, 5 mM CaCl₂, 4 mM MgCl₂, 10 mM N-[2-hydroxyethyl]piperazine-N′-2-ethanesulfonic acid] (HEPES), 50 mM sucrose, with 5% volume/volume bovine calf serum and 50 IU ml⁻¹ penicillin and 50 μg ml⁻¹ streptomycin added, and the pH adjusted to 7.4 using NaOH. The TAG is carefully dissected and placed in sterile Ca²⁺/Mg²⁺-free insect saline containing 200 mM NaCl, 3.1 mM KCl, 10 mM HEPES, 60 mM sucrose, 50 IU/mL penicillin, and 50 IU/ml streptomycin, with the pH adjusted to 7.4 using NaOH. The ganglia are then desheathed and incubated for 20 minutes in Ca²⁺/Mg²⁺-free insect saline containing 1.5 mg/ml collagenase. The ganglia are rinsed three times in normal insect saline. The resulting suspension is distributed into eight wells of a 24-well cluster plate. Each well contains a 12-mm diameter glass coverslip that had been previously coated with concanavalin A (2 mg/ml). Isolated cells attach to coverslips overnight in an incubator (100% relative humidity, 37° C.).

In one embodiment, electrophysiological experiments employ the patch-clamp recording technique in whole-cell configuration to measure voltage-gated sodium, potassium, and calcium currents from cockroach DUM neurons. Coverslips with isolated cells are transferred to a 1-ml glass-bottom perfusion chamber mounted on the stage of a phase-contrast microscope. Whole-cell recordings of sodium, potassium, and calcium currents are made using an Axopatch 200A-integrating amplifier (Axon Instruments, Foster City, Calif.). Borosilicate glass-capillary tubing is used to pull single-use recording micropipettes.

The contents of the external and internal solutions are varied according to the type of recording procedure undertaken and also the particular ionic current being studied. The holding potential can be, for example, −80 mV. Electrode tip resistances can be in the range 0.8-4.0 MΩ. The osmolarity of both external and internal solutions may be adjusted to 310 mosmol/liter with sucrose to reduce osmotic stress. The liquid junction potential between internal and external solutions may be determined using the program JPCalc.

In one embodiment, large tear-shaped DUM neurons with diameters greater than 45 μm are selected for experiments. Inverted voltage-clamp command pulses are applied to the bath through an Ag/AgCl pellet/3 M KCl-agar bridge. After formation of a gigaohm seal, suction is applied to break through the membrane. Experiments should not commence for a period of 5 to 10 minutes to allow for complete block of unwanted currents.

Stimulation and recording may both be controlled by an AxoData data acquisition system (Axon Instruments) running on an Apple Macintosh computer. Data is filtered at 5 kHz (low-pass Bessel filter) and digital sampling rates are between 15 and 25 kHz depending on the length of the voltage protocol. Leakage and capacitive currents are digitally subtracted with P—P/4 procedures. Data analysis is performed off-line following completion of the experiment. I/V data are fitted by nonlinear regression of the following equation onto the data:
I=g_{max{}1−(1/(1+exp[V−V_{1/2})/s]))}(V−Vᵣₑᵥ)
where I is the amplitude of the peak current at a given potential, V; gₘₐₓ is the maximal conductance; V_{1/2} is the voltage at half-maximal activation; s is the slope factor; and Vᵣₑᵥ is the reversal potential.

In another embodiment, the insect ion channel comprises a heterologously expressed insect calcium-activated potassium channel (also known as BK_{Ca}, K_{Ca} 0.1, Maxi-K, or Sio1), such as the pore-forming α subunit of the pSlo channel from the cockroach Periplaneta americana. Human embryonic kidney (HEK293) cells (American Type Culture Collection, Bethesda, Md., USA) are maintained in Dulbecco's Modified Eagle's Medium (DMEM/High Modified, JRH Biosciences, Lenexa Kans., USA) supplemented with 10% bovine calf serum. Expression of pSlo channels (P. americana high conductance calcium-activated potassium channel channels) is performed by transfection of the HEK293 cells with a construct containing the pSlo coding region cloned into the expression vector pcDNA3.1, which also carries the G418 resistance gene (Invitrogen BV, San Diego, Calif., USA). HEK293 monolayers in 35 mm² dishes are transfected using 9 μl Lipofectamine Reagent (Gibco, BRL) and 5 μg DNA. Stably transfected cells are then selected with 1000 μg ml⁻¹ G418 (Gibco, Grand Island, N.Y., USA). These cells are maintained in the normal growth media described above and cultured on sterile glass coverslips to be used for the patch clamp experiments.

Whole-cell pSlo channel currents are measured at room temperature using borosilicate pipettes (Harvard Apparatus Ltd, Kent, UK) with resistances of 2-4 MΩ. Current measurements are made using an Axopatch 200A-integrating amplifier (Axon Instruments, Foster City, Calif., USA). In all experiments the holding potential is −90 mV. To record pSlo whole-cell currents, pipettes are filled with a solution containing 4 mM NaCl, 140 mM KCl, 2 mM ATP-Mg₂, 0.6 mM CaCl₂, and 10 mM N-(2-hydroxyethyl)piperazine-N′-[2-ethanesulfonic acid] (HEPES), with the pH adjusted to 7.25 with 2 M KOH. The external solution contains 135 mM NaCl, 5 mM KCl, 1 mM MgCl₂, 1 mM CaCl₂, 0.33 mM NaH₂PO₄, 10 mM glucose, and 10 mM HEPES, with the pH adjusted to 7.4 with 2 M NaOH. The osmolarity is approximately 290 mosmol/L. After breaking through the membrane, experiments do not commence for a period of 10-15 min to allow formation of >2 MΩ seals.

The efficacy of a test compound can be expressed as the IC₅₀ (the dose that inhibits 50% of the activity) of an insect calcium channel or insect calcium-activated potassium channel. Compounds which have an IC₅₀ of less than 1 nanomolar, specifically less than 25 micromolar and more specifically less than 1 micromolar. The effective insecticidal amount of such compounds lies preferably within a range of concentrations that include the IC₅₀.

(3) Other ion channel assays. It will be understood by those skilled in the art that a number of alternative assays are suitable to determine whether a putative mimic of rU-ACTX-Hv1a modulates the activity of a specific insect ion channel. Examples include, but are not limited to: (1) radioactive flux assays, such as the use of ⁸⁶Rb⁺ to measure the activity of potassium channels (Cheng et al., Drug. Dev. Ind. Pharm. 28, 177-191, 2002); and (2) voltage-sensor assays in which membrane-potential-sensitive fluorescent dyes are used to indirectly monitor channel activity by monitoring changes in membrane potential (Gonzalez, J. E. and Maher, M. P., Receptors and Channels 8, 283-295, 2002).

In an exemplary radioactive flux assay, the human ether-a go-go-related gene (HERG), that encodes the pore-forming subunit of cardiac Ikr potassium (K⁺) channels, is used to transfect Chinese hamster ovary (CHO) cells. Cells are seeded into 96-well plates at a density of about 200 cells/μL of media. After seeding, the cells are incubated at 37° C. and 5% CO₂ overnight prior to use. For the Rb efflux assay, the cell culture medium is changed to rubidium (⁸⁶Rb). Cells are incubated with ⁸⁶Rb for four hours, the medium is removed and the cells are washed. The cells are washed with a 40 mM K⁺ test buffer containing: 105 mM NaCl, 2 mM CaCl₂, 40 mM KCl, 2 mM MgCl₂, 10 mM HEPES, and 10 mM glucose. The pH is adjusted to 7.4 with NaOH. Test compounds are carried in the high K⁺ test buffer. The effect of the test compounds on the channels is measured using electrophysiology recordings. Electrodes have resistances between 2 and 3 MΩ when filled with internal solution. The internal solution contains: 100 mM KF, 40 mM KCl, 5 mM NaCl, 10 mM EGTA, and 10 mM HEPES, adjusted to pH 7.4 with KOH. The cells are perfused with external solution containing: 140 mM NaCl, 2 mM CaCl₂, 5 mM KCl, 2 mM MgCl₂, 10 mM glucose, and 10 mM HEPES, adjusted to pH 7.4 with NaOH. The junction potential may be calculated using pClaamp 8 software. Currents may be filtered at 5 kHz on an Axopatch-1D amplifier (Axon Instruments) and recorded onto a PC with sample rate of 1 kHz using pClamp 8 (Axon Instruments). Data may be analyzed using Clampfit (Axon Instruments) and Origin software (Microcal).

In another exemplary embodiment, membrane-potential-sensitive fluorescent dyes are used to indirectly monitor channel activity by monitoring changes in membrane potential. Membrane potential sensors based on FRET are useful for high throughput screening of ion channels. In one embodiment, the sensor is a two-component sensor comprising a first component that is a highly fluorescent hydrophobic ion that binds to the plasma membrane and senses the membrane potential and a second component that is a fluorescent molecule that binds to one face of the plasma membrane and functions as a FRET partner to the mobile voltage sensing ion. In one embodiment, the first component is a coumarin-labeled phospholipid (CC2-DMPE) and the second component is a bis-(1,3-dialkylthiobarbituric acid) trimethine oxonol, DiSBACn(3), where n corresponds to the number of carbon atoms in the n alkyl group. Vertex, for example, has developed a kinetic plate reader that is compatible with such FRET-based voltage sensors. The VIPR™ is a 96- or 384-well integrated liquid handler and fluorescent reader, The reader uses a scanning fiber optic illumination and detection system. Other similar systems and probes may also be employed.

(4) Surface Binding Studies. A variety of binding assays are useful in screening new molecules for their binding activity. One approach includes surface plasmon resonance (SPR), which could be used, for example, to evaluate whether the molecules of interest bind to an insect voltage-gated calcium channel or an insect calcium-activated potassium channel.

SPR methodologies measure the interaction between two or more macromolecules in real-time through the generation of a quantum mechanical surface plasmon. One device, the BIAcore Biosensor™ (Pharmacia, Piscataway, N.J.), provides a focused beam of polychromatic light to the interface between a gold film (provided as a disposable biosensor “chip”) and a buffer compartment that can be regulated by the user. A 100 nm thick “hydrogel” composed of carboxylated dextran which provides a matrix for the covalent immobilization of analytes of interest is attached to the gold film. When the focused light interacts with the free electron cloud of the gold film, plasmon resonance is enhanced. The resulting reflected light is spectrally depleted in wavelengths that optimally evolved the resonance. By separating the reflected polychromatic light into its component wavelengths (by means of a prism), and determining the frequencies which are depleted, the BIAcore establishes an optical interface which accurately reports the behavior of the generated surface plasmon resonance. When deigned as above, the plasmon resonance (and thus the depletion spectrum) is sensitive to mass in the evanescent field (which corresponds roughly to the thickness of the hydrogel). If one component of an interacting pair is immobilized to the hydrogel, and the interacting partner is provided through the buffer compartment, the interaction between the two components is measured in real time based on the accumulation of mass in the evanescent field and its corresponding effects of the plasmon resonance as measured by the depletion spectrum. This system permits rapid and sensitive real-time measurement of the molecular interactions without the need to label either component. SPR is useful, for example, to evaluate whether a putative mimic of rU-ACTX-Hv1a was able to competitively displace this peptide toxin from an insect ion channel.

(5) Fluorescence Polarization. Fluorescence polarization (FP) is a measurement technique is readily applied to protein-protein and protein-ligand interactions in order to derive IC₅₀ and K_{d} values for the association reaction between two molecules. In this technique, one of the molecules of interest is conjugated with a fluorophore. This is generally the smaller molecule, such as a small-molecule mimic of rU-ACTX-Hv1a. The sample mixture, containing both the conjugated small molecule and either an insect voltage-gated calcium channel or an insect calcium-activated potassium channel, is excited with vertically polarized light. Light is absorbed by the probe fluorophores, and re-emitted a short time later. The degree of polarization of the emitted light is measured. Polarization of the emitted light is dependent on several factors, such as on viscosity of the solution and on the apparent molecular weight of the fluorophore. With proper controls, changes in the degree of polarization of the emitted light depends only on changes in the apparent molecular weight of the fluorophore, which in-turn depends on whether the probe-ligand conjugate is free in solution, or is bound to a receptor. Binding assays based on FP have a number of important advantages, including the measurement of IC₅₀ and K_{d} values under true homogenous equilibrium conditions, speed of analysis, amenity to automation, and ability to screen in cloudy suspensions and colored solutions.

(6) Competition with rU-ACTX-Hv1a. In one embodiment, the ability of a molecule to mimic the binding of rU-ACTX-Hv1a to a particular insect ion channel is measured from its ability to competitively displace rU-ACTX-Hv1a from that channel. For example, fluorescently or radioactively labeled rU-ACTX-Hv1a are first bound to neuronal membranes or cell lines containing the ion channel of interest. One then measures the ability of the compound of interest to competitively displace rU-ACTX-Hv1a and cause the release of labeled toxin into the medium. Repetition of the displacement assay with varying concentrations of the molecule of interest permit its IC₅₀ value to be calculated and compared with that of other putative mimics, enabling the molecules to be ranked in order of binding affinity.

Furthermore, high-throughput screening may be used to speed up analysis using such assays. As a result, it may be possible to rapidly screen new molecules for their ability to interact with an insect ion channel using the tools and methods disclosed herein. General methodologies for performing high-throughput screening are described, for example, in U.S. Pat. No. 5,763,263, incorporated herein by reference. High-throughput assays can use one or more different assay techniques including, but not limited to, those described above.

Once identified, the active molecules are optionally incorporated into a suitable carrier prior to use. More specifically, the dose of active molecule, mode of administration, and use of suitable carrier will depend upon the target and non-target organism(s) of interest.

A method of controlling an insect comprises contacting the insect or an insect larva with an insecticidally effective amount of a U-ACTX mimic. The U-ACTX mimic may be, for example, in the form of a small organic molecule, a chemical compound, a purified polypeptide, a polynucleotide encoding the U-ACTX mimic optionally in an expression vector, an insect virus expressing the U-ACTX mimic, a cell such as a plant cell or a bacterial cell expressing the U-ACTX mimic, or a transgenic plant expressing the U-ACTX mimic. The U-ACTX mimic is optionally fused to, or delivered in conjunction with, an agent that enhances the activity of the compound when ingested by insects, such as snowdrop lectin or one of the Bacillus thuringiensis δ-endotoxins. Contacting includes, for example, injection of the U-ACTX mimic, external contact, ingestion of the U-ACTX mimic, or ingestion of a polynucleotide, virus, or bacterium expressing the U-ACTX mimic.

A method of treating a plant comprises contacting the plant with an insecticidally effective amount of a U-ACTX mimic. The U-ACTX mimic is, for example, in the form of a small organic molecule, a chemical compound, a purified polypeptide, a polynucleotide encoding the U-ACTX mimic optionally in an expression vector, a virus expressing the U-ACTX mimic, or a cell such as a plant cell or a bacterial cell expressing the U-ACTX mimic.

In one embodiment, there is provided an insecticidal composition comprising a U-ACTX mimic and an agriculturally acceptable carrier, diluent and/or excipient. In another embodiment, an insecticidal composition comprises a virus expressing a U-ACTX mimic. Insect viruses can be replicated and expressed inside a host insect once the virus infects the host insect. Infecting an insect with an insect virus can be achieved via methods, including, for example, ingestion, inhalation, direct contact of the insect or insect larvae with the insect virus, and the like.

The insecticidal composition is, for example, in the form of a flowable solution or suspension such as an aqueous solution or suspension. Such aqueous solutions or suspensions are provided as a concentrated stock solution which is diluted prior to application, or alternatively, as a diluted solution ready-to-apply. In another embodiment, an insecticide composition comprises a water dispersible granule. In yet another embodiment, an insecticide composition comprises a wettable powder, dust, pellet, or colloidal concentrate. Such dry forms of the insecticidal compositions are formulated to dissolve immediately upon wetting, or alternatively, dissolve in a controlled-release, sustained-release, or other time-dependent manner.

When the U-ACTX mimics are expressed by an insect virus, the virus expressing the U-ACTX mimic can be applied to the crop to be protected. The virus may be engineered to express a U-ACTX mimic, either alone or in combination with one or several other U-ACTX polypeptides or mimics, or in combination with other insecticides such as other insecticidal polypeptide toxins that may result in enhanced or synergistic insecticidal activity. Suitable viruses include, but are not limited to, baculoviruses.

When the insecticidal compositions comprise intact cells (e.g., bacterial cells) expressing a U-ACTX mimic, such cells are formulated in a variety of ways. They may be employed as wettable powders, granules or dusts, by mixing with various inert materials, such as inorganic minerals (phyllosilicates, carbonates, sulfates, phosphates, and the like) or botanical materials (powdered corncobs, rice hulls, walnut shells, and the like), and combinations comprising one or more of the foregoing materials. The formulations may include spreader-sticker adjuvants, stabilizing agents, other pesticidal additives, surfactants, and combinations comprising one or more of the foregoing additives. Liquid formulations may be aqueous-based or non-aqueous and employed as foams, suspensions, emulsifiable concentrates, and the like. The ingredients may include rheological agents, surfactants, emulsifiers, dispersants, polymers, liposomes, and combinations comprising one or more of the foregoing ingredients.

Alternatively, the U-ACTX mimics are expressed in vitro and isolated for subsequent field application. Such mimics are, for example, in the form of crude cell lysates, suspensions, colloids, etc., or may be purified, refined, buffered, and/or further processed, before formulating in an active insecticidal formulation.

Regardless of the method of application, the amount of the active component(s) is applied at an insecticidally-effective amount, which will vary depending on such factors as, for example, the specific insects to be controlled, the specific plant or crop to be treated, the environmental conditions, and the method, rate, and quantity of application of the insecticidally-active composition.

Insecticidal compositions comprising the U-ACTX mimics are, for example, formulated with an agriculturally-acceptable carrier. The compositions may be formulated prior to administration in an appropriate means such as lyophilized, freeze-dried, desiccated, or in an aqueous carrier, medium or suitable diluent, such as saline or other buffer. The formulated compositions may be in the form of a dust or granular material, or a suspension in oil (vegetable or mineral), or water or oil/water emulsions, or as a wettable powder, or in combination another other carrier material suitable for agricultural application. Suitable agricultural carriers can be solid or liquid and are well known in the art. The term “agriculturally-acceptable carrier” covers all adjuvants, e.g., inert components, dispersants, surfactants, tackifiers, binders, etc. that are ordinarily used in insecticide formulation technology; these are well known to those skilled in insecticide formulation. The formulations may be mixed with one or more solid or liquid adjuvants and prepared by various means, e.g., by homogeneously mixing, blending and/or grinding the insecticidal composition with suitable adjuvants using conventional formulation techniques.

The insecticidal compositions are, for example, applied to the environment of the target insect, for example onto the foliage of the plant or crop to be protected, by methods, preferably by spraying. The strength and duration of insecticidal application may be set with regard to conditions specific to the particular pest(s), crop(s) to be treated, and particular environmental conditions. The proportional ratio of active ingredient to carrier will naturally depend on the chemical nature, solubility, and stability of the insecticidal composition, as well as the particular formulation contemplated.

Other application techniques, e.g., dusting, sprinkling, soaking, soil injection, seed coating, seedling coating, spraying, aerating, misting, atomizing, and the like, are also feasible and may be required under certain circumstances such as, for example, control of insects that cause root or stalk infestation, or for application to delicate vegetation or ornamental plants. These application procedures are also well-known to those of skill in the art.

The insecticidal compositions are employed singly or in combination with other compounds, including but not limited to other pesticides. They may be used in conjunction with other treatments such as surfactants, detergents, polymers or time-release formulations. The insecticidal compositions optionally comprise an insect attractant. The insecticidal compositions are formulated for either systemic or topical use. Such agents may are optionally applied to insects directly.

The concentration of the insecticidal composition that is used for environmental, systemic, or foliar application varies depending upon the nature of the particular formulation, means of application, environmental conditions, and degree of biocidal activity.

Alternatively, a crop is engineered to express a U-ACTX mimic, either alone, or in combination with insecticidal polypeptide toxins that may result in enhanced or synergistic insecticidal activity. Crops for which this approach would be useful include, but are not limited to, cotton, tomato, sweet corn, lucerne, soybean, sorghum, field pea, linseed, safflower, rapeseed, sunflower, and field lupins.

Arthopods of suitable agricultural, household and/or medical/veterinary importance for treatment with the insecticidal polypeptides include, for example, members of the classes and orders: Coleoptera such as the American bean weevil Acanthoscelides obtectus, the leaf beetle Agelastica alni, click beetles (Agriotes lineatus, Agriotes obscurus, Agriotes bicolor), the grain beetle Ahasverus advena, the summer schafer Amphimallon solstitialis, the furniture beetle Anobium punctatum, Anthonomus spp. (weevils), the Pygmy mangold beetle Atomaria linearis, carpet beetles (Anthrenus spp., Attagenus spp.), the cowpea weevil Callosobruchus maculatus, the fried fruit beetle Carpophilus hemipterus, the cabbage seedpod weevil Ceutorhynchus assimilis, the rape winter stem weevil Ceutorhynchus picitarsis, the wireworms Conoderus vespertinus and Conoderus falli, the banana weevil Cosmopolites sordidus, the New Zealand grass grub Costelytra zealandica, the June beetle Cotinis nitida, the sunflower stem weevil Cylindrocopturus adspersus, the larder beetle Dermestes lardarius, the corn rootworms Diabrotica virgifera, Diabrotica virgifera virgifera, and Diabrotica barberi, the Mexican bean beetle Epilachna varivestis, the old house borer Hylotropes bajulus, the lucerne weevil Hypera postica, the shiny spider beetle Gibbium psylloides, the cigarette beetle Lasioderma serricorne, the Colorado potato beetle Leptinotarsa decemlineata, Lyctus beetles (Lyctus spp.), the pollen beetle Meligethes aeneus, the common cockshafer Melolontha melolontha, the American spider beetle Mezium americanum, the golden spider beetle Niptus hololeucus, the grain beetles Oryzaephilus surinamensis and Oryzaephilus mercator, the black vine weevil Otiorhynchus sulcatus, the mustard beetle Phaedon cochleariae, the crucifer flea beetle Phyllotreta cruciferae, the striped flea beetle Phyllotreta striolata, the cabbage steam flea beetle Psylliodes chrysocephala, Ptinus spp. (spider beetles), the lesser grain borer Rhizopertha dominica, the pea and been weevil Sitona lineatus, the rice and granary beetles Sitophilus oryzae and Sitophilus granarius, the red sunflower seed weevil Smicronyx fulvus, the drugstore beetle Stegobium paniceum, the yellow mealworm beetle Tenebrio molitor, the flour beetles Tribolium castaneum and Tribolium confusum, warehouse and cabinet beetles (Trogoderma spp.), and the sunflower beetle Zygogramma exclamationis; Dermaptera (earwigs) such as the European earwig Forficula auricularia and the striped earwig Labidura riparia; Dictyoptera such as the oriental cockroach Blatta orientalis, the German cockroach Blatella germanica, the Madeira cockroach Leucophaea maderae, the American cockroach Periplaneta americana, and the smokybrown cockroach Periplaneta fuliginosa; Diplopoda such as the spotted snake millipede Blaniulus guttulatus, the flat-back millipede Brachydesmus superus, and the greenhouse millipede Oxidus gracilis; Diptera such as the African tumbu fly (Cordylobia anthropophaga), biting midges (Culicoides spp.), bee louse (Braula spp.), the beet fly Pegomyia betae, black flies (Cnephia spp., Eusimulium spp., Simulium spp.), bot flies (Cuterebra spp., Gastrophilus spp., Oestrus spp.), craneflies (Tipula spp.), eye gnats (Hippelates spp.), filth-breeding flies (Calliphora spp., Fannia spp., Hermetia spp., Lucilia spp.; Musca spp., Muscina spp., Phaenicia spp., Phormia spp.), flesh flies (Sarcophaga spp., Wohlfahrtia spp.); the frit fly Oscinella frit, fruitflies (Dacus spp., Drosophila spp.), head and carion flies (Hydrotea spp.), the hessian fly Mayetiola destructor, horn and buffalo flies (Haematobia spp.), horse and deer flies (Chrysops spp., Haematopota spp., Tabanus spp.), louse flies (Lipoptena spp., Lynchia spp., and Pseudolynchia spp.), medflies (Ceratitus spp.), mosquitoes (Aedes spp., Anopheles spp., Culex spp., Psorophora spp.), sandflies (Phlebotomus spp., Lutzomyia spp.), screw-worm flies (Chrysomya bezziana and Cochliomyia hominivorax), sheep keds (Melophagus spp.); stable flies (Stomoxys spp.), tsetse flies (Glossina spp.), and warble flies (Hypodenna spp.); Isoptera(termites) including species from the familes Hodotermitidae, Kalotermitidae, Mastotermitidae, Rhinotermitidae, Serritermitidae, Termitidae, Termopsidae; Heteroptera such as the bed bug Cimex lectularius, the cotton stainer Dysdercus intermedius, the Sunn pest Eurygaster integriceps, the tarnished plant bug Lygus lineolaris, the green stink bug Nezara antennata, the southern green stink bug Nezara viridula, and the triatomid bugs Panstrogylus megistus, Rhodnius ecuadoriensis, Rhodnius pallescans, Rhodnius prolixus, Rhodnius robustus, Triatoma dimidiata, Triatoma infestans, and Triatoma sordida; Homopterasuch as the California red scale Aonidiella aurantii, the black bean aphid Aphis fabae, the cotton or melon aphid Aphis gossypii, the green apple aphid Aphis pomi, the citrus spiny whitefly Aleurocanthus spiniferus, the oleander scale Aspidiotus hederae, the sweet potato whitefly Bemesia tabaci, the cabbage aphid Brevicoryne brassicae, the pear psylla Cacopsylla pyricola, the currant aphid Cryptomyzus ribis, the grape phylloxera Daktulosphaira vitifoliae, the citrus psylla Diaphorina citri, the potato leafhopper Empoasca fabae, the bean leafhopper Empoasca solana, the vine leafhopper Empoasca vitis, the woolly aphid Eriosoma lanigerum, the European fruit scale Eulecanium corni, the mealy plum aphid Hyalopterus arundinis, the small brown planthopper Laodelphax striatellus, the potato aphid Macrosiphum euphorbiae, the green peach aphid Myzus persicae, the green rice leafhopper Nephotettix cinticeps, the brown planthopper Nilaparvata lugens, gall-forming aphids (Pemphigus spp.), the hop aphid Phorodon humuli, the bird-cherry aphid Rhopalosiphum padi, the black scale Saissetia oleae, the greenbug Schizaphis graminum, the grain aphid Sitobion avenae, and the greenhouse whitefly Trialeurodes vaporariorum; Isopoda such as the common pillbug Armadillidium vulgare and the common woodlouse Oniscus asellus; Lepidoptera such as Adoxophyes orana (summer fruit tortrix moth), Agrotis ipsolon (black cutworm), Archips podana (fruit tree tortrix moth), Bucculatrix pyrivorella (pear leafininer), Bucculatrix thurberiella (cotton leaf perforator), Bupalus piniarius (pine looper), Carpocapsa pomonella (codling moth), Chilo suppressalis (striped rice borer), Choristoneura fumiferana (eastern spruce budworm), Cochylis hospes (banded sunflower moth), Diatraea grandiosella (southwestern corn borer), Earis insulana (Egyptian bollworm), Euphestia kuehniella (Mediterranean flour moth), Eupoecilia ambiguella (European grape berry moth), Euproctis chrysorrhoea (brown-tail moth), Euproctis subflava (oriental tussock moth), Galleria mellonella (greater wax moth), Helicoverpa armigera (cotton bollworm), Helicoverpa zea (cotton bollworm), Heliothis virescens (tobacco budworm), Hofinannophila pseudopretella (brown house moth), Homeosoma electellum (sunflower moth), Homona magnanima (oriental tea tree tortrix moth), Lithocolletis blancardella (spotted tentiform leafminer), Lymantria dispar (gypsy moth), Malacosoma neustria (tent caterpillar), Mamestra brassicae (cabbage armyworm), Mamestra configurata (Bertha armyworm), the hornworms Manduca sexta and Manuduca quinquemaculata, Operophtera brumata (winter moth), Ostrinia nubilalis (European corn borer), Panolis flammea (pine beauty moth), Pectinophora gossypiella (pink bollworm), Phyllocnistis citrella (citrus leafininer), Pieris brassicae (cabbage white butterfly), Plutella xylostella (diamondback moth), Rachiplusia ni (soybean looper), Spilosoma virginica (yellow bear moth), Spodoptera exigua (beet armyworm), Spodoptera frugiperda (fall armyworm), Spodoptera littoralis (cotton leafworm), Spodoptera litura (common cutworm), Spodoptera praefica (yellowstriped armyworm), Sylepta derogata (cotton leaf roller), Tineola bisselliella (webbing clothes moth), Tineola pellionella (case-making clothes moth), Tortrix viridana (European oak leafroller), Trichoplusia ni (cabbage looper), Yponomeuta padella (small ermine moth); Orthoptera such as the common cricket Acheta domesticus, tree locusts (Anacridium spp.), the migratory locust Locusta migratoria, the twostriped grasshopper Melanoplus bivittatus, the differential grasshopper Melanoplus differentialis, the redlegged grasshopper Melanoplus femurrubrum, the migratory grasshopper Melanoplus sanguinipes, the northern mole cricket Neocurtilla hexadectyla, the red locust Nomadacris septemfasciata, the shortwinged mole cricket Scapteriscus abbreviatus, the southern mole cricket Scapteriscus borellii, the tawny mole cricket Scapteriscus vicinus, and the desert locust Schistocerca gregaria; Phthiraptera such as the cattle biting louse Bovicola bovis, biting lice (Damalinia spp.), the cat louse Felicola subrostrata, the shortnosed cattle louse Haematopinus eurysternus, the tail-switch louse Haematopinus quadripertussus, the hog louse Haematopinus suis, the face louse Linognathus ovillus, the foot louse Linognathus pedalis, the dog sucking louse Linognathus setosus, the long-nosed cattle louse Linognathus vituli, the chicken body louse Menacanthus stramineus, the poultry shaft louse Menopon gallinae, the human body louse Pediculus humanus, the pubic louse Phthirus pubis, the little blue cattle louse Solenopotes capillatus, and the dog biting louse Trichodectes canis; Psocoptera such as the booklice Liposcelis bostrychophila, Liposcelis decolor, Liposcelis entomophila, and Trogiumpulsatorium; Siphonaptera such as the bird flea Ceratophyllus gallinae, the dog flea Ctenocephalides canis, the cat flea Ctenocephalides felis, the human flea Pulex irritans, and the oriental rat flea Xenopsylla cheopis; Symphyla such as the garden symphylan Scutigerella immaculata; Thysanura such as the gray silverfish Ctenolepisma longicaudata, the four-lined silverfish Ctenolepisma quadriseriata, the common silverfish Lepisma saccharina, and the firebrat Thermobia domestica; Thysanoptera such as the tobacco thrips Frankliniella fusca, the flower thrips Frankliniella intonsa, the western flower thrips Frankliniella occidentalis, the cotton bud thrips Frankliniella schultzei, the banded greenhouse thrips Hercinothrips femoralis, the soybean thrips Neohydatothrips variabilis, Kelly's citrus thrips Pezothrips kellyanus, the avocado thrips Scirtothrips perseae, the melon thrips Thrips palmi, and the onion thrips Thrips tabaci; and the like, and combinations comprising one or more of the foregoing insects.

In one embodiment, the insecticidal compositions comprising the U-ACTX mimics are employed to treat ectoparasites. Ectoparasites include, for example, fleas, ticks, mange, mites, mosquitoes, nuisance and biting flies, lice, and combinations comprising one or more of the foregoing ectoparasites. The term fleas includes the usual or accidental species of parasitic flea of the order Siphonaptera, and in particular the species Ctenocephalides, in particular C. felis and C. canis, rat fleas (Xenopsylla cheopis) and human fleas (Pulex irritans). Ectoparasites on farm animals (e.g., cattle), companion animals (e.g., cats and dogs), and humans may be treated. In the case of farm and domestic animals, treatment may include impregnation in a collar or topical application to a localized region followed by diffusion through the animal's dermis and/or accumulation in sebaceous glands. In the case of humans, treatment may include a composition suitable for the treatment of lice in humans. Such a composition may be suitable for application to a human scalp such as a shampoo or a conditioner.

The invention is further illustrated by the following non-limiting examples.

### EXAMPLES

### Example 1

### Production of rU-ACTX-Hv1a for Structure-Function Studies

A derivative of the prototypic U-ACTX family member, rU-ACTX-Hv1a (SEQ ID NO:1) (FIG. 1), was chosen for structure-function analyses. A synthetic gene for rU-ACTX-Hv1a, with codons optimized for expression in Escherichia coli, was cloned into a pGEX-2T plasmid and the resulting derivative plasmid (PBLS 1) was used to transform E. coli BL21 cells. The toxin is produced from this plasmid as a fusion to the C-terminus of glutathione S-transferase (GST), with a thrombin cleavage site between the GST and toxin coding regions. The cells were grown in LB medium at 37° C. to an A₆₀₀ of 0.6-0.8 before induction of the fusion protein with 300 μM isopropyl-1-thio-β-D-galactopyranoside (IPTG). The cells were harvested by centrifugation at an A₆₀₀ of 1.9-2.1 and frozen until further use. Cell pellets were defrosted and then resuspended in lysis buffer (50 mM NaCl, 50 mM Tris, 1 mM EDTA, pH 8.0). Cells were then lysed by sonication. The recombinant fusion protein was purified from the soluble cell fraction using affinity chromatography on GSH-Sepharose columns (Amersham Biosciences). After purification on the column, the column beads were equilibrated and resuspended in thrombin buffer (150 mM NaCl, 20 mM Tris, 1 mM CaCl₂, pH 8.0) before addition of 50 U bovine thrombin (Sigma). The column was placed in a 37° C. incubator overnight to allow proteolytic cleavage of the fusion protein. The liberated toxin was eluted from the column with Tris-buffered saline (150 mM NaCl, 50 mM Tris, pH 8.0). The toxin was purified immediately using reverse-phase (rp) HPLC before being lyophilized. Lyophilized toxin was then resuspended in the appropriate buffer.

The correctly folded recombinant toxin was separated from non-native disulfide bond isomers and other contaminants by rpHPLC using a Vydac C₁₈ analytical column (4.6×250 mm, 5-μm pore size). The toxin was eluted from the column at a flow rate of 1 ml min⁻¹ using a linear gradient of 10-18% acetonitrile over 20 minutes. Correctly folded toxin eluted as the major peak with a retention time of 9-10 minutes. The toxin molecular weight was verified using electrospray mass spectrometry. The yield of the correctly folded recombinant toxin was estimated from integration of the relevant HPLC peaks and found to be ˜70-80%.

### Example 2

### Determination of the Three-Dimensional Structure of rU-ACTX-Hv1a

NMR experiments were performed using a four-channel Varian INOVA 600

NMR spectrometer equipped with pulse-field gradients. All experiments were performed at 25° C. All data were processed using NMRPipe. Processed spectra were analyzed and peaks were integrated using the program XEASY.

Data from 3D HNCACB, CBCA(CO)NH, HNCACO, HNHA, and HNHB experiments were used for making backbone ¹H, ¹⁵N, and ¹³C chemical shift assignments. Chemical shift assignments for side chain atoms were made using 3D C(CO)NH-TOCSY, HC(CO)NH-TOCSY and HCCH—COSY spectra. The complete set of ¹H, ¹⁵N, and ¹³C chemical shift assignments for rU-ACTX-Hv1a have been deposited in BioMagResBank with Accession Number 7117.

Interproton distance restraints were obtained from integration of peak intensities in 3D ¹⁵N-edited NOESY and ¹³C-edited NOESY spectra. NOE assignments were initially made using the CANDID macro in CYANA, then refined manually. Crosspeak intensities from NOESY spectra were converted into distance restraints using the CALIBRA macro in the program CYANA.

Dihedral-angle restraints were obtained from TALOS analysis of H_{α}, C_{α}, C_{β}, and H_{N} chemical shifts; for structure calculations, the range of each restraint was set to twice the standard deviation of the TALOS prediction. The analysis of H_{N}-H_{β} couplings derived from the 3D HNHB experiment, coupled with H_{α}-H_{β} and H_{N}-H_{β} NOE intensities measured from ¹⁵N-edited and ¹³C-edited NOESY experiments, were used to generate XI restraints and stereo-specific assignments of β-methylene protons. Other stereospecific assignments were made by analysis of preliminary structures computed using the computer program CYANA.

Disulfide bonds were assigned from the experimentally determined disulfide-bond pattern in the co-ACTX-Hv1a and J-ACTX-Hv1c toxins, which are part of the same toxin superfamily. The disulfide bonds in rU-ACTX-Hv1a are thus Cys3-Cys18, Cys10-Cys23, and Cys17-Cys37.

Hydrogen bonds were determined in two ways: (i) from direct observation of hydrogen-bond scalar couplings in a 2D HNCO experiment; (ii) from analysis of a hydrogen-deuterium exchange experiment in which a sample of lyophilized rU-ACTX-Hv1a was dissolved in 100% D₂O and the exchange of H_{N} protons with solvent deuterons was monitored from the change in peak intensities in a time course of 2D HSQC spectra. These analyses led to the assignment of 14 hydrogen bonds, as summarized in Table 1. For structure calculations, the O—N and O—H_{N} distance for each hydrogen bond was restrained to range of 2.7-3.1 Å and 1.7-2.1 Å, respectively.

TABLE 1
Hydrogen bonds observed in the structure of rU-ACTX-Hv1a

| Hydrogen bond | Bonded residue |
|---|---|
| 4HN | 16O |
| 7HN | 37O |
| 8HN | 5O |
| 10HN | 35O |
| 18HN | 4O |
| 21HN | 18O |
| 22HN | 38O |
| 24HN | 36O |
| 26HN | 34O |
| 32HN | 28OD1 |
| 34HN | 26O |
| 36HN | 24O |
| 37HN | 8O |
| 38HN | 22O |

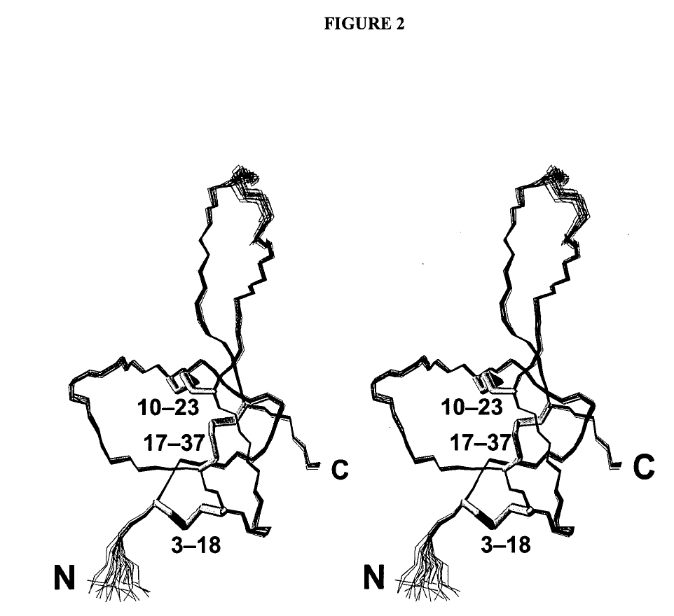

Using all experimentally-derived restraints, 1000 rU-ACTX-Hv1a structures were calculated from random starting structures using the computer program CYANA. The best 60 structures, defined as those with the lowest final penalty function values, were then refined by dynamical simulated annealing using the computer program X-PLOR. The 25 structures with the lowest molecular energies in X-PLOR were chosen to represent the rU-ACTX-Hv1a structure (FIG. 2). The atomic coordinates for the ensemble of 25 rU-ACTX-Hv1a structures, along with the list of restraints used for structure calculations, have been deposited in the Protein Data Bank under Accession Number 2H1Z.

The ensemble of rU-ACTX-Hv1a structures is highly precise; the root mean squared deviation (rmsd) over the backbone N, C′, and C_{α} atoms of the well-defined region (residues 3-39) is 0.14±0.05 Å relative to a calculated mean coordinate structure. The rmsd over all heavy atoms of residues 3-39 is 0.59±0.07 Å relative to the mean coordinate structure.

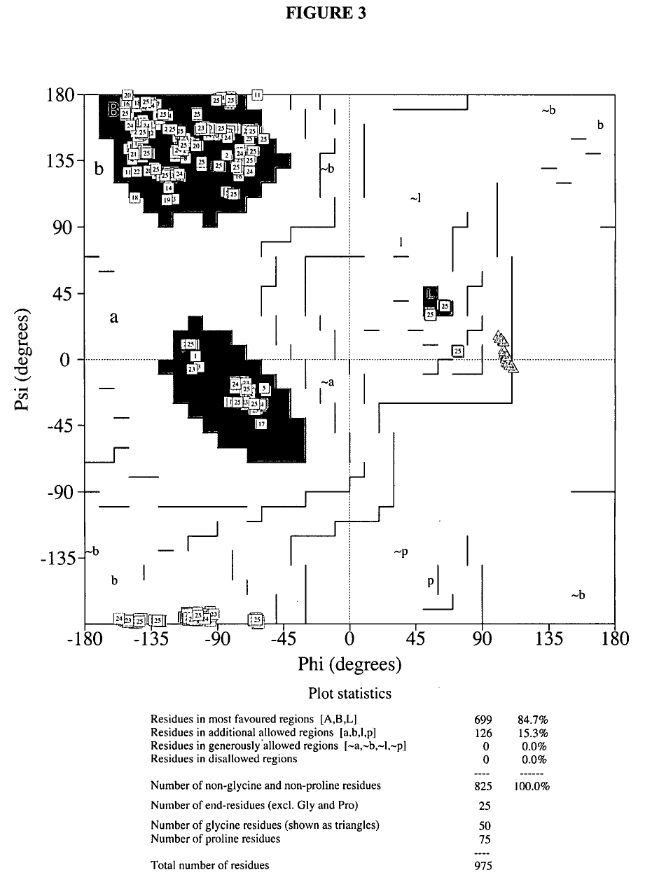

Analysis of the ensemble of rU-ACTX-Hv1a structures using the program PROCHECK indicated that 85% of the non-Gly/non-Pro residues lie in the “most favored” region of a Ramachandran plot, while the remaining 15% lie in “additionally allowed” regions (FIG. 3). There are no residues in the disallowed region (FIG. 3).

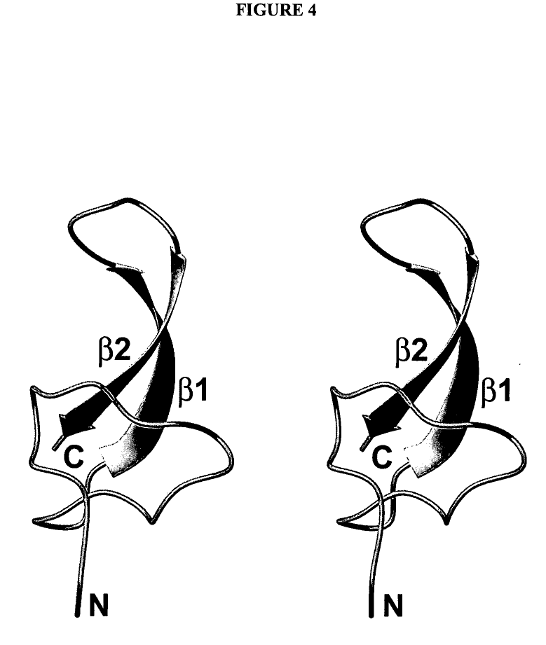

FIG. 4 shows a Richardson schematic of the three-dimensional structure of rU-ACTX-Hv1a generated using the computer program MOLMOL. The major secondary structure element is a C-terminal β-hairpin comprising β-strand 1 (β1, residues 22-27) and β-strand 2 (β2, residues 33-38).

### Example 3

### Determination of the Functional Pharmacophoric Specification of rU-ACTX-Hv1a

Residues that are critical for the function of rU-ACTX-Hv1a were determined using alanine scanning mutagenesis. In this approach, individual residues were mutated to alanine, then the activity of the mutant toxin was compared to that of wild-type rU-ACTX-Hv1a (SEQ ID NO: 1). The six cysteine residues comprising the inhibitory cysteine knot motif of rU-ACTX-Hv1a (i.e., Cys3, Cys10, Cys17, Cys18, Cys23, and Cys37) were excluded from the alanine scan because they are presumed to be important for defining the three-dimensional structure of the toxin; these buried cysteine residues are not expected to interact with the insect ion channels targeted by rU-ACTX-Hv1a. Ala21 and Ala39 were also not mutated. The remaining 28 non-alanine residues present in the primary structure of rU-ACTX-Hv1a were mutated individually to alanine.

Most of the mutant toxins were successfully overproduced in Escherichia coli as soluble GST fusion proteins, as described above for wild-type rU-ACTX-Hv1a. However, the L10A fusion protein proved to insoluble, and further mutation of this residue was not pursued.

The alanine side chain can be accommodated in most types of polypeptide secondary structure (i.e., α-helix, β-sheet, and β-turn) and therefore it is commonly utilized in scanning mutagenesis in order to minimize the possibility of introducing major structural perturbations. However, even though alanine substitutions are usually structurally well-tolerated, each rU-ACTX-Hv1a mutant was analyzed for structural perturbations relative to the wild-type toxin. Samples of rU-ACTX-Hv1a (SEQ ID NO:1) and mutants thereof were prepared for acquisition of 2D ¹H-¹⁵N HSQC spectra by overproduction in Escherichia coli BL21 cells grown in minimal media with ¹⁵N as the sole nitrogen source. The 2D HSQC spectrum of each uniformly ¹⁵N-labeled mutant toxin was compared with the HSQC spectrum of wild-type rU-ACTX-Hv1a acquired using identical experimental conditions. If the HSQC spectrum of the mutant toxin superimposed closely on the HSQC spectrum of rU-ACTX-Hv1a, it was concluded that the introduced alanine substitution does not cause any significant structural perturbations in the mutant toxin.

HSQC spectra were quantitatively compared by measuring the difference between the chemical shift of each peak in the HSQC spectrum of rU-ACTX-Hv1a and the chemical shift of the corresponding peak in the spectrum of the mutant toxin. The chemical shift difference (Δδ) was calculated using the following equation:
Δδ=[(0.17*Δδ_{N})²+Δδ_{H}²]^{1/2} (Equation 1)
where Δδ_{N} and Δδ_{H} are the differences in chemical shifts of HSQC peaks in the nitrogen (¹⁵N) and proton (¹H) dimensions respectively.

A mutant was considered structurally perturbed relative to rU-ACTX-Hv1a if 10% or more of the peaks in the HSQC spectrum had Δδ values greater than 0.25 ppm. Based on this criterion, only four mutant toxins showed chemical shift differences indicative of a structural perturbation. The HSQC spectrum of the E26A mutant was dramatically different to that of rU-ACTX-Hv1a, indicating a major structural perturbation. It was therefore excluded from the functional assays. The HSQC spectra of three other mutants, namely, T14A, Y35A and R38A, revealed that peaks from 4-6 residues has Δδ>0.25 ppm, indicative of a minor structural perturbation.

The in vivo activity of each of the remaining 27 alanine-scan mutants was determined by assessing their LD₅₀ values, relative to that of rU-ACTX-Hv1a, when injected into house flies (Musca domestica). 20 of the mutants exhibited less than a five-fold decrease in insecticidal activity relative to rU-ACTX-Hv1a (see Table 2). It was concluded that these 20 residues are not critical for toxin activity. There are seven residues for which mutation to alanine led to more than a 5-fold decrease in insecticidal activity; these residues are Gln8, Pro9, Asn28, Thr33, Val34, Tyr35, and Tyr36. However, the HSQC structural analysis outlined above indicated that the Y35A mutant was structurally perturbed relative to the wild-type rU-ACTX-Hv1a structure. Thus, there are six residues that appear to be important for the insecticidal activity of rU-ACTX-Hv1a: Gln8, Pro9, Asn28, Thr33, Val34, and Tyr36.

The most critical residues for the insecticidal action or rU-ACTX-Hv1a are Gln8, Pro9, Asn28, and Val34, since mutation of these residues to alanine causes a 19-164-fold reduction in insecticidal potency. In contrast, mutation of Thr33 and Tyr36 to alanine causes only a small 5.3-7.2-fold reduction in toxin activity. The four critical residues are located in close proximity on a single face of the toxin (FIG. 5) and they most likely represent the primary epitope for interaction of the toxin with target insect ion channels. These residues are the primary pharmacophoric elements of rU-ACTX-Hv1a.

The four primary pharmacophoric elements make up a nearly contiguous feature on the surface of the toxin, which is the functional pharmacophoric specification (FIG. 5). The surface area bounded by these residues is similar to that of typical organic insecticide or pharmaceutical agent.

TABLE 2
LD₅₀ values and fold-reduction in activity of mutant toxins

| | | Fold-reduction | Correctly |
|---|---|---|---|
| Peptide toxin | LD₅₀ (pmol g⁻¹)^{a} | in activity^{b} | folded?^{c} |
| U-ACTX-Hv1a | 76 ± 7 | — | YES |
| (SEQ ID NO: 1) | | | |
| U-ACTX-Hv1a (V4A) | 58 ± 10 | 0.76 | YES |
| U-ACTX-Hv1a (P5A) | 329 ± 29 | 4.32 | YES |
| U-ACTX-Hv1a (V6A) | 79 ± 52 | 1.04 | YES |
| U-ACTX-Hv1a (D7A) | 44 ± 2 | 0.58 | YES |
| U-ACTX-Hv1a (Q8A) | 1445 ± 253 | 19.0 | YES |
| U-ACTX-Hv1a (P9A) | 2069 ± 576 | 27.2 | YES |
| U-ACTX-Hv1a (S10A) | 24 ± 5 | 0.31 | YES |
| U-ACTX-Hv1a (N13A) | 158 ± 29 | 2.08 | YES |
| U-ACTX-Hv1a (T14A) | 97 ± 8 | 1.28 | NO |
| U-ACTX-Hv1a (Q15A) | 134 ± 16 | 1.76 | YES |
| U-ACTX-Hv1a (P16A) | 67 ± 20 | 0.88 | YES |
| U-ACTX-Hv1a (D19A) | 144 ± 61 | 1.89 | YES |
| U-ACTX-Hv1a (D20A) | 30 ± 2 | 0.39 | YES |
| U-ACTX-Hv1a (T22A) | 41 ± 8 | 0.54 | YES |
| U-ACTX-Hv1a (T24A) | 111 ± 11 | 1.46 | YES |
| U-ACTX-Hv1a (Q25A) | 240 ± 98 | 3.15 | YES |
| U-ACTX-Hv1a (R27A) | 119 ± 3 | 1.57 | YES |
| U-ACTX-Hv1a (N28A) | 12,473 ± 898 | 4.1 | YES |
| U-ACTX-Hv1a (E29A) | 80 ± 15 | 1.05 | YES |
| U-ACTX-Hv1a (N30A) | 99 ± 3 | 1.30 | YES |
| U-ACTX-Hv1a (G31A) | 215 ± 37 | 2.82 | YES |
| U-ACTX-Hv1a (H32A) | 184 ± 25 | 2.42 | YES |
| U-ACTX-Hv1a (T33A) | 547 ± 96 | 7.19 | YES |
| U-ACTX-Hv1a (V34A) | 3350 ± 53 | 4.1 | YES |
| U-ACTX-Hv1a (Y35A) | 1329 ± 201 | 7.5 | NO |
| U-ACTX-Hv1a (Y36A) | 400 ± 81 | 5.26 | YES |
| U-ACTX-Hv1a (R38A) | 375 ± 21 | 4.93 | NO |

^{a}LD₅₀ values were determined by injection into Musca domestica.
^{b}The fold-reduction in activity for each of the mutant toxins, relative to the wild-type toxin (SEQ ID No: 1), was calculated as (LD₅₀ of mutant)/(LD₅₀ of U-ACTX-Hv1a). A value less than 1.00 indicates that the mutant is more active than the native toxin (SEQ ID NO: 1).
^{c}Folding was assessed by comparing the HSQC spectrum of the mutant with that of rU-ACTX-Hv1a.

Disclosed herein are methods of identifying structural and/or functional mimics of the U-ACTX polypeptide which are useful as insecticides. In particular, a molecular model made from the atomic coordinates for the rU-ACTX-Hv1a insecticidal toxin having PDB ID 2H1Z and RCSB ID RCSB037828 is employed to identify a candidate molecule that mimics the structure of the rU-ACTX-Hv1a molecular model. Identifying the pharmacophoric residues Q⁸, P⁹, N²⁸, and V³⁴ in the molecular model while using the molecular model aids in identifying functional U-ACTX mimics. In particular, mimics exhibiting lethality to insects, inhibition of insect calcium channels, inhibition of insect calcium-activated potassium channels, binding to insect calcium channels, binding to insect calcium-activated potassium channels, or a combination of one or more of the foregoing are particularly desirable.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. All ranges disclosed herein are inclusive and combinable.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

All cited patents, patent applications, and other references are incorporated herein by reference in their entirety.

Table 3 containing the coordinates for U-ACTX is submitted on Compact Disk 1. The information on Compact Disk 1 is incorporated herein by reference.

1. A method of identifying a candidate molecule that mimics at least a portion of a three-dimensional structure of a U-ACTX insecticidal toxin, comprising:
providing a molecular model made from the atomic coordinates for the rU-ACTX-Hv1a insecticidal toxin as in Table 3;
using the molecular model to identify a candidate molecule that mimics the structure of the rU-ACTX-Hv1a molecular model; and
providing the candidate molecule that is identified.

2. The method of claim 1, further comprising identifying the pharmacophoric residues Q⁸, P⁹, N²⁸, and V³⁴ in the molecular model while using the molecular model.

3. The method of claim 1, wherein providing comprises synthesizing the candidate molecule or obtaining the candidate molecule from a library.

4. The method of claim 1, further comprising testing the candidate molecule in a functional assay.

5. The method of claim 4, wherein the functional assay comprises testing for lethality to insects, inhibition of insect calcium channels, inhibition of insect calcium-activated potassium channels, binding to insect calcium channels, binding to insect calcium-activated potassium channels, or a combination of one or more of the foregoing functional assays.

6. The method of claim 4, further comprising using the molecular model to identify a modified candidate molecule to identify and produce a modified candidate molecule having a higher lethality to insects, enhanced inhibition of insect calcium channels, enhanced inhibition of insect calcium-activated potassium channels, enhanced binding to insect calcium channels, enhanced binding to insect calcium-activated potassium channels, or an enhancement of one or more of the foregoing functionalities relative to the candidate molecule.

7. The method of claim 6, wherein the functional assay measures inhibition of Caᵥ channel currents in DUM neurons from P. americana, inhibition of a cockroach pSlo channel, or a combination comprising one or more of the foregoing assays.

8. A method for selecting a candidate molecule that mimics at least a portion of a three-dimensional structure of rU-ACTX-Hv1a, comprising:
providing a computer having a memory means, a data input means, and a visual display means, the memory means containing three-dimensional molecular simulation software operable to retrieve coordinate data from the memory means and to display a three-dimensional representation of rU-ACTX-Hv1a on the visual display means;
inputting three-dimensional coordinate data of atoms of rU-ACTX-Hv1 from Table 3 into the computer and storing the data in the memory means;
displaying the three-dimensional representation of the candidate molecule on the visual display means;
comparing the three-dimensional structure of rU-ACTX-Hv1a and the candidate molecule; and
providing the candidate molecule.

9. The method of claim 8, further comprising identifying the pharmacophoric residues Q⁸, P⁹, N²⁸, and V³⁴ in the molecular model while using the molecular model.

10. The method of claim 8, wherein providing comprises synthesizing the candidate molecule or obtaining the candidate molecule from a library.

11. The method of claim 8, further comprising testing the candidate molecule in a functional assay.

12. The method of claim 11, wherein the functional assay comprises testing for lethality to insects, inhibition of insect calcium channels, inhibition of insect calcium-activated potassium channels, binding to insect calcium channels, binding to insect calcium-activated potassium channels, or a combination of one or more of the foregoing functional assays.

13. The method of claim 11, further comprising using the molecular model to identify a modified candidate molecule to identify and produce a modified candidate molecule having a higher lethality to insects, enhanced inhibition of insect calcium channels, enhanced inhibition of insect calcium-activated potassium channels, enhanced binding to insect calcium channels, enhanced binding to insect calcium-activated potassium channels, or an enhancement of one or more of the foregoing functionalities relative to the candidate molecule.

14. The method of claim 13, wherein the functional assay measures inhibition of Caᵥ channel currents in DUM neurons from P. americana, inhibition of the cockroach pSlo channel, or a combination comprising one or more of the foregoing assays.

15. A method of identifying a molecule that mimics at least a portion of a three-dimensional structure of a U-ACTX insecticidal toxin, comprising:
generating a three-dimensional model of the U-ACTX polypeptide,
identifying pharmacophoric residues Q⁸, P⁹, N²⁸, and V³⁴ in the three-dimensional model, and
performing a computer analysis to identify a candidate molecule that mimics the pharmacophoric residues of the U-ACTX polypeptide.

16. The method of claim 15, further comprising, prior to generating a three-dimensional model,
obtaining a purified U-ACTX polypeptide, and
obtaining atomic coordinates for the U-ACTX polypeptide.

17. The method of claim 15, wherein the U-ACTX insecticidal toxin comprises an amino acid sequence that is greater than or equal to about 70% identical to SEQ ID NO: 1, wherein the polypeptide has insecticidal activity.

18. The method of claim 15, wherein the U-ACTX insecticidal toxin comprises an amino acid sequence that is greater than or equal to about 85% identical to SEQ ID NO:1, wherein the polypeptide has insecticidal activity.

19. The method of claim 15, wherein the U-ACTX insecticidal toxin comprises an amino acid sequence that is greater than or equal to about 90% identical to SEQ ID NO:1, wherein the polypeptide has insecticidal activity.

20. The method of claim 15, further comprising:
testing the candidate molecule in a functional assay for lethality to insects, inhibition of insect calcium channels, inhibition of insect calcium-activated potassium channels, binding to insect calcium channels, binding to insect calcium-activated potassium channels, or a combination of one or more of the foregoing functional assays.

21. The method of claim 20, further comprising using the molecular model to identify a modified candidate molecule to identify and produce a modified candidate molecule having a higher lethality to insects, enhanced inhibition of insect calcium channels, enhanced inhibition of insect calcium-activated potassium channels, enhanced binding to insect calcium channels, enhanced binding to insect calcium-activated potassium channels, or an enhancement of one or more of the foregoing functionalities relative to the candidate molecule.

22. The method of claim 21, wherein the functional assay measures inhibition of Caᵥ channel currents in DUM neurons from P. americana, inhibition of the cockroach pSlo channel, or a combination comprising one or more of the foregoing assays.
